(19) United States
(12) Patent Application Publication
(10) Pub. No.: US 2022/0104506 A1
(43) Pub. Date: Apr. 7, 2022

(54) Freezer-To-Oven Dough Product Having Multiple Layers with Varying Densities

(71) Applicant: General Mills, Inc., Minneapolis, MN (US)

(72) Inventors: Steven J. Cox, Long Lake, MN (US); David J. Domingues, Plymouth, MN (US); Craig A. Dowd, Eagan, MN (US); James Fudge, Champlin, MN (US); Kara M. Hobart, New Hope, MN (US)

(73) Assignee: General Mills, Inc., Minneapolis, MN (US)

(21) Appl. No.: 17/065,047

(22) Filed: Oct. 7, 2020

(51) Int. Cl. A21D 10/02; A21D 8/02

(52) U.S. Cl. CPC A21D 10/02; A21D 8/02

(57) ABSTRACT

A frozen, ready-to-bake dough product has an expanded dough core and an un-proofed dough veneer. The dough core is proofed before being enveloped by the outer dough veneer to form a dual density dough product having an inner, lower density body portion and an outer, higher density body portion, with the outer body portion constituting more than half of the overall body mass. The dual density dough product is frozen into a ready-to-bake dough product. Upon baking directly from the frozen state, a surface area of the dough product expands less than 60% while a volume of the dough product basically doubles due to expansion of the dough veneer, with the dough veneer establishing a crust for a light and airy inner bread body.

### FIELD OF THE INVENTION

The invention pertains to the art of food production and, more particularly, to the mass production of freezer-to-oven, multi-layered, varying density dough products.

### BACKGROUND

A number of methods have been employed in order to make various types of bread products, such as loaves, buns, rolls, biscuits, and breadsticks. In commercial systems, a bread dough may typically be extruded, reduced and provided to a conveyor which conveys the dough along a dough travel path. The dough then encounters one or more cutting apparatus, such as slitter wheels, guillotine-type cutters, reciprocating head cutters, rotatable drum-type cutters or the like. The resulting dough products can then be frozen and shipped for resale, such as to grocery stores for purchase directly by consumers, restaurants, bakery stores, or the like.

Regardless of the destination, the frozen dough product must be cooked prior to consumption. When looking to bake frozen dough products, it is common to initially thaw the dough products prior to baking. However, it is also known to have frozen dough products which are intended to go directly from a freezer to an oven, i.e. freezer-to-oven (FTO) dough products. Certainly, the baking times increase when the frozen dough products are not thawed prior to baking.

Freezer-to-oven (FTO) dough products can be particularly advantageous to retail bakers, so long as the quality of the resulting baked product mimics both the visual and taste characteristics of fresh baked dough products. Typically, a trade-off is made between the relative ease of producing baked products from FTO dough products versus a seemingly inherent loss in at least product size and appearance. The present invention overcomes the need for such a trade-off through the specific formation of a frozen, ready-to-bake, dual density dough product.

### SUMMARY OF THE INVENTION

In accordance with certain product aspects, the invention is directed to producing a frozen, ready-to-bake dough product including an expanded dough core and an un-proofed dough veneer enveloping the expanded dough core. The un-proofed dough veneer covers at least 70%, and up to 100%, of the outer surface area of the expanded dough core. The frozen, ready-to-bake dough product is particularly characterized by the un-proofed dough veneer having a greater density than the expanded dough core, with the density of the un-proofed dough veneer being in the order of 2-3 times greater than the density of the expanded dough core. In a preferred form, the expanded dough core has a density of 0.5 g/cc or less, and the un-proofed dough veneer has a density of 0.8 to 1.1 g/cc.

In accordance with method aspects of the invention, the dough core is proofed before being enveloped by the un-proofed outer dough veneer to form a dual density dough product having an inner, lower density body portion and an outer, higher density body portion, with the outer body portion constituting more than half of the overall body mass. The dual density dough product is frozen into the ready-to-bake dough product. Upon baking directly from the frozen state, a surface area of the dough product expands less than 60%, while a volume of the dough product basically doubles due to expansion of the dough veneer. Overall, the cooked dough product substantially mimics both visual and structural characteristics of a traditional baker's bread product made from a homogeneous, partially or fully proofed dough mass which has not been frozen, with the dough veneer of the invention establishing a crust for a light and airy inner bread body.

In any case, additional objects, features and advantages of the invention will become more readily apparent from the following detailed description of the invention when taken in conjunction with the drawings wherein like reference numerals refer to corresponding parts in the several views.

### BRIEF DESCRIPTION OF THE DRAWINGS

FIG. 1 illustrates a freezer-to-oven, multi-layered, varying density dough product prior to baking as produced in accordance with the present invention;

FIG. 2 is a cross-section of the freezer-to-oven, multi-layered, varying density dough product of FIG. 1; and

FIG. 3 is a perspective view of a bread product produced by baking the freezer-to-oven, multi-layered, varying density dough product of FIG. 1.

### DETAILED DESCRIPTION OF THE INVENTION

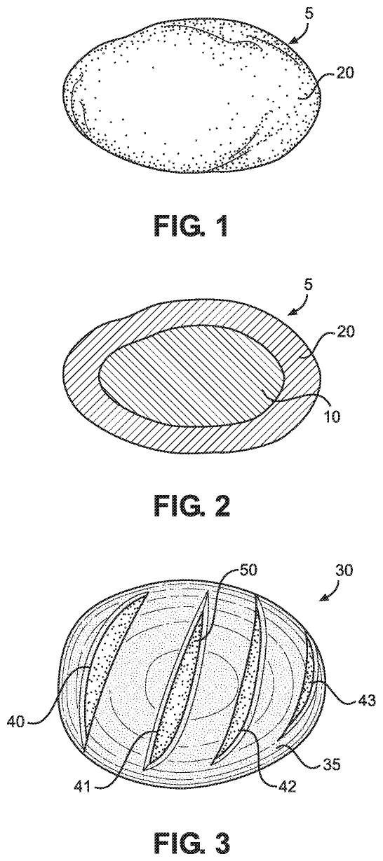

With initial reference to FIGS. 1 and 2, a ready-to-bake, freezer-to-oven, multi-layered, varying density dough product 5 produced in accordance with the present invention is depicted. As shown, dough product 5 includes an inner dough core 10 which is wrapped or enveloped in an outer dough veneer 20. More preferably, dough product 5 consists only of inner dough core 10 and outer dough veneer 20. Inner dough core 10 has an outer surface area which is at least 70% covered by the outer dough veneer 20. More preferably, the entire outer surface area of inner dough core 10 is completely covered by the outer dough veneer 20 such that inner dough core 10 is totally encapsulated by outer dough veneer 20.

Important in connection with the invention is that inner dough core 10 constitutes an expanded dough, i.e., a dough which has already been fully proofed, while outer dough veneer 20 is dough which has not been proofed. In accordance with the invention, proofing of inner dough core 10 can be achieved in various ways known in the art, including extrusion expansion, chemical leavening and yeast fermentation. On the other hand, outer dough veneer 20 is un-proofed which, in accordance with the invention, means that outer dough veneer 20 has not expanded by more than 10% prior to freezing. Therefore, inner dough core 10 is proofed prior to being enveloped by outer dough veneer 20. Thereafter, the entire dough product 5 is frozen.

As the outer dough veneer 20 has not been proofed, the frozen, ready-to-bake dough product 5 is particularly characterized by the un-proofed dough veneer 20 having a greater density than the expanded inner dough core 10, with the density of the un-proofed outer dough veneer 20 being in the order of 2-3 times greater than the density of the expanded inner dough core 10. In a preferred form, the expanded inner dough core 10 has a density of 0.5 g/cc or less, and the un-proofed outer dough veneer 20 has a density of 0.8 to 1.1 g/cc. At the same time, the un-proofed outer dough veneer 20 has a mass which is greater than a mass of inner dough core 10 such that outer dough veneer 20 constitutes more than half, i.e., a majority, by mass of the overall dough product 5. More preferably, outer dough veneer 20 establishes approximately 60% of the mass of dough product 5.

As indicated above, the dual density dough arrangement is frozen to establish the ready-to-bake, freezer-to-oven, multi-layered, varying density dough product 5. At this point, it should again be realized that the invention enables dough product 5 to be mass produced, shipped and delivered such as to a retail baker in a frozen state, and then baked from the frozen state to replicate a hand or fresh made dough product. By way of example, dough product 5 can be baked from a frozen state to make a finished dough product 30 as shown in FIG. 3. In this preferred embodiment of the invention, outer dough veneer 20 constitutes a yeast dough having viable yeast, e.g., a temperature controlled leavener, prior to being baked (with or without steam injection), while extrusion expansion or chemical leavening is utilized with inner dough core 10 based on the relative ease of control. Upon baking directly from the frozen state, an outer surface area of dough product 5 expands (based on first-to-thaw and delayed proofing) less than 60%, while a volume of dough product 5 at least doubles (expands at least two times during baking) directly due to expansion of outer dough veneer 20 which establishes an outer crust 35 of finished dough product 30. Given the significant expansion of outer dough veneer 20, a plurality of spaced slits or tears 40-43 are formed, exposing a more light and airy inner bread body 50.

Certainly the dough masses establishing the inner core and the outer veneer of the dough product can be formed in various ways. For instance, the dough masses can be created at the same or different times, as well as from many common ingredients or vastly different formulations. In one form of the invention, the core dough piece and the core dough piece are coextruded, with only the core dough piece being expanded upon extrusion through pressure differential. Although disclosed with reference to making a loaf of bread, the invention can be employed in making a wide variety of baked dough products, including loaves, buns, rolls, biscuits, breadsticks, and the like. Therefore, although described with reference to certain embodiments, it should be readily understood that various changes and/or modifications may be made in form and detail without departing from the spirit and scope of the invention as encompassed by the following claims.

1. A frozen, ready-to-bake dough product comprising:
an expanded dough core; and
an un-proofed dough veneer enveloping the expanded dough core, wherein the un-proofed dough veneer has a greater density than the expanded dough core, said expanded dough core and said un-proofed dough veneer being frozen and ready for baking.

2. The frozen, ready-to-bake dough product of claim 1, wherein the un-proofed dough veneer has a density in the order of 2-3 times greater than the expanded dough core.

3. The frozen, ready-to-bake dough product of claim 2, wherein the dough product has an average density of 0.67 g/cc or less.

4. The frozen, ready-to-bake dough product of claim 2, wherein the expanded dough core has a density of 0.5 g/cc or less, and the un-proofed dough veneer has a density of 0.8 to 1.1 g/cc.

5. The frozen, ready-to-bake dough product of claim 1, wherein the expanded dough core has an outer surface area and the un-proofed dough veneer covers at least 70% of the outer surface area.

6. The frozen, ready-to-bake dough product of claim 5, wherein the un-proofed dough veneer entirely covers the outer surface area so as to encapsulate the expanded dough core.

7. The frozen, ready-to-bake dough product of claim 1, wherein a mass of the un-proofed dough veneer is greater than a mass of the expanded dough core.

8. The frozen, ready-to-bake dough product of claim 1, wherein the un-proofed dough veneer comprises a majority by mass of the dough product.

9. The frozen, ready-to-bake dough product of claim 8, wherein the un-proofed dough veneer comprises approximately 60% by mass of the dough product.

10. The frozen, ready-to-bake dough product of claim 1, wherein the un-proofed dough veneer is a yeast dough having viable yeast prior to being baked.

11. A method for producing a dough product comprising:
forming a core dough piece which is pre-proofed and expanded;
enveloping the core dough piece with an un-proofed dough veneer which is at least twice as dense as the core dough piece to form a dual density dough product; and
freezing the dual density dough product into a ready-to-bake dough product.

12. The method of claim 11, further comprising cooking the dual density dough product directly from a frozen state into a finished dough product, with the dough veneer establishing a crust for the finished dough product.

13. The method of claim 12, wherein the dough piece is cooked through a baking operation.

14. The method of claim 13, further comprising expanding a volume of the dual density dough product by at least two times during baking.

15. The method of claim 14, wherein an outer surface area of the dual density dough product expands less than 60% upon baking.

16. The method of claim 11, further comprising: coextruding the core dough piece and the core dough piece, with the core dough piece being expanded upon extrusion.
